(19) United States
(12) Patent Application Publication
(10) Pub. No.: US 2006/0181650 A1
(43) Pub. Date: Aug. 17, 2006

(54) Encoding method and device

(76) Inventor: Sandra Del Corso, Clamart (FR)

Correspondence Address: PHILIPS INTELLECTUAL PROPERTY & STANDARDS, P.O. BOX 3001, BRIARCLIFF MANOR, NY, 10510, US

(21) Appl. No.: 10/564,424

(22) PCT Filed: Jul. 9, 2004
(86) PCT No.: PCT/IB04/02287

§ 371 Date: Jan. 11, 2006

(30) Foreign Application Priority Data
Jul. 16, 2003 (EP) 03300063.9

(51) Int. Cl. H04N 5/14

(52) U.S. Cl. 348/699; 375/240.12

(57) ABSTRACT

The invention relates to an encoding method applied to an input video sequence comprising successive frames partitioned in subframes and comprising the steps of estimating a motion vector for each subframe, transforming, quantizing and coding a so-called input residual signal, generating a predicted frame, generating a motion-compensated predicted frame on the basis of said predicted frame and the motion vectors, and, by difference between the current frame and said motion-compensated predicted frame, generating said input residual signal. According to the invention, the encoding method is characterized in that the predicted frame generating step is followed by a temporal filtering sub-step carried out on the predicted frame, before the motion compensated predicted frame generating step.

### FIELD OF THE INVENTION

The present invention relates to an encoding method applied to an input video sequence comprising successive frames partitioned in subframes, said method comprising at least the following steps of:
estimating a motion vector for each subframe of the current frame to be encoded;
transforming, quantizing and coding a so-called input residual signal;
on the basis of the signals obtained after the quantizing step, generating a predicted frame by means of at least an inverse quantizing step, an inverse transform step and an adding step, with or without a spatial filtering step;
on the basis of said predicted frame and the motion vectors respectively associated to the subframes, generating a motion-compensated predicted frame;
by difference between the current frame and said motion-compensated predicted frame, generating said input residual signal.

The present invention also relates to a device for carrying out such an encoding method.

### BACKGROUND OF THE INVENTION

An image encoder such as described for example in the document WO 97/16029 mainly comprises the following modules: motion estimation, motion compensation, rate control, DCT (discrete cosine transform), quantization, VLC (variable length coding), buffer, inverse quantization, inverse DCT transform, subtractor and adder. In such an encoder, the quantization process is a lossy treatment that leads to blocking artifacts. The document WO 00/49809 (PHF99508) relates to a method of removing or at least reducing these artifacts, based on the principle of implementing in the decoding process a spatial filtering step, allowing to cancel or at least reduce these spatial artifacts due to the blocky structure of the signals to be encoded.

### SUMMARY OF THE INVENTION

The object of the invention is to propose a new type of encoder, allowing to still improve the visual quality of the image reconstructed at the decoding side.

To this end, the invention relates to an image encoder such as defined in the introductory part of the description and which is moreover characterized in that the predicted frame generating step is followed by a temporal filtering sub-step carried out on the predicted frame, before the motion compensated predicted frame generating step.

The advantage of this structure is that the compression factor of the encoded image sequence at the encoding side is improved, which leads to a better visual quality of the reconstructed image sequence at the decoding side.

### BRIEF DESCRIPTION OF DRAWINGS

The present invention will now be described, by way of example, with reference to the accompanying drawings in which:

FIG. 1 shows an example of conventional image encoder;

FIG. 2 shows an encoding device according to the invention.

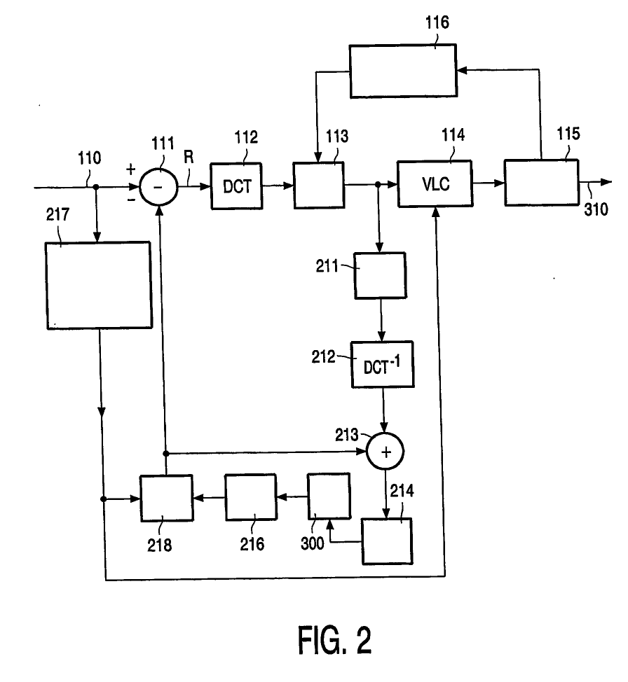

### DETAILED DESCRIPTION OF THE INVENTION

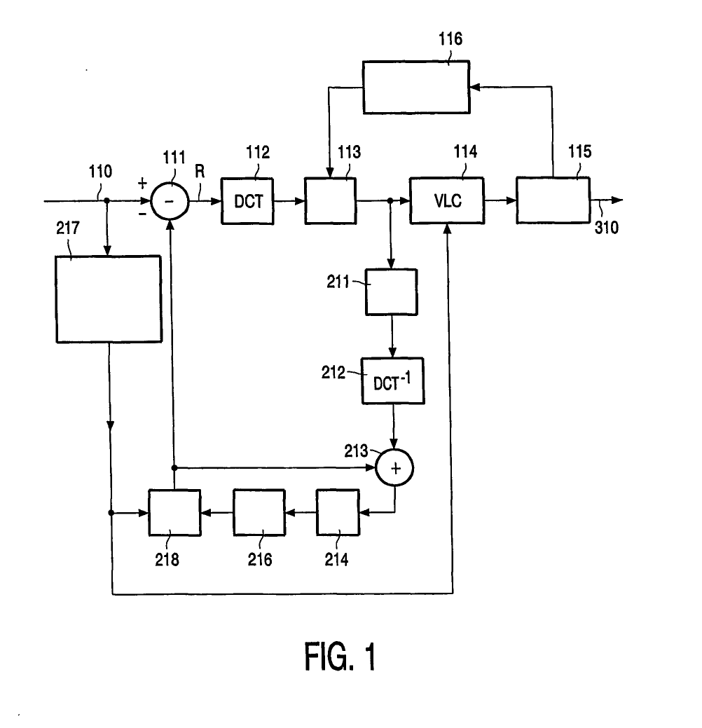

A block diagram of a conventional encoding device is given in FIG. 1. Such a device generally comprises a coding branch and a prediction branch. The coding branch, the input of which receives an input video sequence 110 subdivided into subframes, comprises in series a subtractor 111, a DCT circuit 112, a quantization circuit 113, an entropy coder such as a VLC circuit 114, a buffer 115 and a rate control circuit 116. The prediction branch comprises, in series between the output of the quantization circuit 113 and the negative input of the subtractor 111, an inverse quantization circuit 211, an inverse DCT circuit 212, an adder 213, a frame memory circuit 216 and a motion compensation circuit 218. A deblocking filter (referenced 214) may be provided in the prediction branch, between the output of the adder 213 and the input of the frame memory 216. The prediction branch also comprises, between the input of the coding branch and said motion compensation circuit 218, a motion estimation circuit 217.

In the present case, the input video sequence is digitized and represented in the form of a luminance signal and two difference signals (in accordance with the MPEG standards), and further divided into a plurality of layers (sequence, group of pictures, picture, or frame, slice, macroblock and block, each picture being represented by a plurality of macroblocks that are in the present implementation the subframes mentioned above). Each input video signal is received by the motion estimation circuit 217 for estimating motion vectors, and these motion vectors available at the output of said motion estimation circuit 217 are received by the motion compensation circuit 218 for improving the efficiency of the prediction. The motion compensation circuit 218 generates a motion compensated prediction (predicted image), which is subtracted via the subtractor 111 from the original video image to form an error signal R or predictive residual signal, received at the input of DCT circuit 112. This DCT circuit then applies a forward DCT process to each block of the predictive residual signal to produce a set of block of DCT coefficients. Each resulting block of DCT coefficients is received by the quantization circuit 113 where the DCT coefficients are quantized. The process of quantization reduces the accuracy with which the DCT coefficients are represented by dividing the DCT coefficients by a set of quantization values with appropriate rounding to form integer values (a different quantization value is applied to each DCT coefficient by means of a quantization matrix established as a reference table, e.g. a luminance quantization table or a chrominance quantization table, and which determines how each frequency coefficient in the transformed block is quantized).

The resulting blocks of quantized DCT coefficients are received by the VLC circuit 114 which encodes the string of quantized DCT coefficients and all side-information for each macroblock (such as macroblock type and motion vectors). At the output of said VLC circuit 114, a coded data stream corresponding to the original input video sequence 110 is now available. This coded data stream is received by the buffer 115, used to match the encoder output to the transmission channel for smoothing the output bit rate. Thus, the output signal 310 of the buffer 115 is a compressed representation of the input video signal, and it is sent to a storage medium or transmission channel. The rate control circuit 116 serves to monitor and adjust the bit rate of the data stream entering the buffer 115, in order to prevent overflow or underflow at the coder side, by controlling the number of bits generated by the encoder.

The quantized DCT coefficients from the quantization circuit 113 are also received by the inverse quantization circuit 211, and the resulting dequantized DCT coefficients are passed to the inverse DCT circuit 212 where inverse DCT is applied to each macroblock to produce the decoded error signal. This error signal is added back to the prediction signal from the motion compensation circuit 218 via the adder 213 to produce a decoded reference picture (reconstructed image) sent to the memory circuit 216.

According to the invention, it is then proposed to add in the prediction branch (with or without the deblocking filter 214), between the output of the adder 213 and the input of the frame memory 216, a temporal filtering circuit 300. Different implementations may be proposed for such a circuit. For example, it could keep in memory (in a memory having the size of an image) the previous (or a previous) image or the following (or a following) image, or keep in memory a lot of past and/or next images and filter corresponding pixels using median filters or filters of a similar nature.

With such a structure, the prediction step is more accurate and the residual signal obtained at the output of the subtractor 111 (by difference between the input signal and the predicted one) is smaller, i.e. the compression factor is improved. The image reconstruction at the decoding side is then performed with a higher quality. It can be noted that, as already said, a deblocking filter 214 may be present, or not, in the prediction branch. The invention is applicable in both cases, whether this spatial filter is present or not.

1. An encoding method applied to an input video sequence comprising successive frames partitioned in subframes, said method comprising at least the following steps of:
estimating a motion vector for each subframe of the current frame to be encoded;
transforming, quantizing and coding a so-called input residual signal;
on the basis of the signals obtained after the quantizing step, generating a predicted frame by means of at least an inverse quantizing step, an inverse transform step and an adding step;
on the basis of said predicted frame and the motion vectors respectively associated to the subframes, generating a motion-compensated predicted frame;
by difference between the current frame and said motion-compensated predicted frame, generating said input residual signal;
said encoding method being further characterized in that the predicted frame generating step is followed by a temporal filtering sub-step carried out on the predicted frame, before the motion compensated predicted frame generating step.

2. An encoding method applied to an input video sequence comprising successive frames partitioned in subframes, said method comprising at least the following steps of:
estimating a motion vector for each subframe of the current frame to be encoded;
transforming, quantizing and coding a so-called input residual signal;
on the basis of the signals obtained after the quantizing step, generating a predicted frame by means of at least an inverse quantizing step, an inverse transform step, a spatial filtering step and an adding step;
on the basis of said predicted frame and the motion vectors associated to the subframes, generating a motion-compensated predicted frame;
by difference between the current frame and said motion-compensated predicted frame, generating said input residual signal
said encoding method being further characterized in that the predicted frame generating step is followed by a temporal filtering sub-step carried out on the predicted frame, before the motion compensated predicted frame generating step.

3. An encoding device provided for carrying out an encoding method according to claim 1.
